(19) United States
(12) Patent Application Publication
(10) Pub. No.: US 2003/0141022 A1
(43) Pub. Date: Jul. 31, 2003

(54) Sash system having doors being openable and closable by sliding and folding

(76) Inventor: Kazumaro Nakatani, Fukui-ken (JP)

Correspondence Address: QUARLES & BRADY LLP, 411 E. WISCONSIN AVENUE, SUITE 2040, MILWAUKEE, WI, 53202-4497, US

(21) Appl. No.: 10/350,648

(22) Filed: Jan. 24, 2003

(30) Foreign Application Priority Data
Jan. 25, 2002 (JP) 2002-017046
Jul. 15, 2002 (JP) 2002-205256

(51) Int. Cl. E06B 3/48

(52) U.S. Cl. 160/118

(57) ABSTRACT

A sash system is provided that can selectively change the use mode of sash doors by means of a simplified engagement/disengagement mechanism. The sash system comprises a pair of sash doors including an inner sash door and an outer sash door; an upper sash frame and a lower sash frame; and an inner guide rail built in the upper frame and an outer guide rail built in the lower frame, the door front frame and the door end frame corresponding to each sash door being always engaged with the inner guide rail and with the outer guide rail, respectively. Each of the sash doors includes a vertical door front frame disposed on the right end of each sash door, a vertical door end frame disposed on the left end of each sash door, a horizontal divider panel connecting the door front frame and the end frame, and an intermediate interlocking frame disposed to a horizontal intermediate portion of the divider panel, the intermediate interlocking frame being two-folded horizontally with respect to a rotational shaft thereof. The intermediate interlocking frame is engaged so as to be detachable from each guide rail or from an interlocking frame guide rail in parallel to each guide rail.

### CROSS REFERENCES TO RELATED APPLICATIONS

This application claims the priority benefit of Japanese Patent Application No. 2002-017046 filed on Jan. 25, 2002 and Japanese Patent Application No. 2002-205256 filed on Jan. 15, 2002.

### STATEMENT REGARDING FEDERALLY SPONSORED RESEARCH

Not Applicable.

### BACKGROUND OF THE INVENTION

1. Field of the Invention

The present invention relates to a sash system having doors, each being freely opened and closed by sliding and folding. More particularly, the present invention relates to an improved sliding sash system having an inner sash door and an outer sash door, each of which can be operated through selecting a sliding open/close mode or a folding open/close mode.

2. Description of the Prior Art

Conventional sash systems of the type, which can be arbitrarily opened and closed through sliding and folding, are well known in Japanese Patent Laid-open publication No. 2002-230018, previously proposed by the present applicant.

In this related art, the sash system has two sash doors including an inner sash door and an outer door sash inside a sash frame. The sash doors are mounted and mutually slidable inside the sash frame integrally assembled in a rectangular form. This sash system has the following structure.

That is, each sash door has a vertical door front frame disposed at the left end thereof, a vertical door end frame disposed at the right end thereof, a horizontal divider panel connecting the door front frame and the door end frame, and a vertical intermediate interlocking frame. The vertical intermediate interlocking frame is disposed at the intermediate portion of the divider panel so as to be two-folded with respect to a rotational shaft. Moreover, the sash frame has an upper frame in which a pair of upper guide rails are built and a lower frame in which a pair of lower guide rails are built. In each sash door, the shaft at the upper end of the door front frame, the shaft at the upper end of the door end frame, and the shaft at the upper end of the intermediate interlocking frame are engaged to the upper guide rails. The shaft at the lower end of the door front frame, the shaft at the lower end of the door end frame, and the shaft at the lower end of the intermediate interlocking frame are engaged to the lower guide rails. The upper shaft of the door front frame is always engaged to the corresponding upper guide rail. The lower shaft of the door front frame is always engaged to the corresponding lower guide rail. The upper shaft of the door end frame is always engaged to the corresponding upper guide rails. The lower shaft of the door end frame is always engaged to the corresponding lower guide rails. The upper shaft of the intermediate interlocking frame can be engaged or disengaged at the position where the corresponding upper guide rail is set. The lower shaft of the intermediate interlocking frame can be engaged or disengaged at the position where the corresponding lower guide rail is set

In the sash system with the above-mentioned structure, the sash doors can be arbitrarily opened and closed mutually by a sliding operation, with the intermediate interlocking frame engaged to the upper and lower guide rails and with each sash door expanded. With the intermediate interlocking frame disengaged from the upper and lower guide rails, each sash door can be opened and closed arbitrarily in a two-fold state.

Each sash door operates in the two use modes of sliding and folding. That is, the upper end shaft of the door front frame is engagable to and disengagable from the upper guide rail and the lower end shaft of the door end frame is engagable to and disengagable from the lower guide rail. With such an engagement/disengagement function, an engagement/disengagement mechanism, for example, formed of an espagnolette and a lever handle, is mounted to an intermediate interlocking frame. The operation of the engagement/disengagement mechanism causes a vertical movement of an L-shaped slider disposed on the indoor side of each intermediate interlocking frame, so that desired engagement and disengagement is achieved.

By operating the engagement/disengagement mechanism located on the intermediate interlocking frame, the intermediate interlocking frame of each sash door is engaged to and disengaged from each upper guide rail while being engaged to and disengaged from each lower guide rail. For that reason, it is not needed to newly machine the upper frame, the lower frame, or the guide rail in a sash frame. In the sash structure, the airtight holding means can easily maintain high air-tightness in a manner similar to that of the conventional double sliding sash system.

After all, the sash system, having an inner sash door and an outer sash door to one sash frame, has the folded opening/closing function, together with the conventional double sliding function maintained in the opening/closing of each sash door. For that reason, the sash system has the advantage of realizing the folded opening/closing function or selectively fully opening, if necessary, a window, in addition to the general double sliding function.

However, in the above-mentioned sash system, the engagement/disengagement mechanism, which changes from opening/closing through sliding and opening/closing through folding, becomes complicated. Moreover, there is an unfavorable problem in that building the engagement/disengagement means in the intermediate interlocking frame leads to a complicated structure.

### SUMMARY OF THE INVENTION

The present invention is made to solve the above-mentioned problems.

An object of the invention is to provide a sash system that can maintain an air-tightness equivalent to (or substantially equivalent to) that of a conventional double-sliding sash system.

Another object of the present invention is to provide an improved sash system that has a simplified engagement/disengagement mechanism. The engagement/disengagement mechanism can selectively provide quickly, easily and reliably the use mode of sliding sash doors engaged by an intermediate interlocking frame along a guide rail or the use mode of folding sash doors disengaged from a guide rail.

In order to solve the conventional problems and to achieve the object of the present invention, the present invention re-studied air-tightness of the sash system of the type which is opened and closed by sliding. With the inner sash door and the outer inner door closed by sliding, the air tightness of the sash system is generally achieved using airtight members. The air tight member is inserted between the upper, lower, right, and left sides of a sash frame and the contact portions between the sash frame and each sash door, or is inserted between door end frames. The present invention paid attention to the fact that the air-tightness is maintained in a closed state of each sash door.

The contact surfaces between sash doors disposed in a closed state may maintain air-tightness in the elongated direction of the upper and lower frames of a sash frame or in the elongated direction of each guide rail. However, it is obvious that other elongated portions of the upper and lower frames and the elongated portions of each guide rail, that is, the outdoor portion and the indoor portion of the inner sash door and the outer sash door disposed in a closed state do not work to maintain air-tightness. The non-airtight maintaining portion is used to engage and disengage the intermediate interlocking frame of each sash door to each guide rail. In other words, the upper and lower shafts of an intermediate interlocking frame are engaged and disengaged by means of a communicating path, such as a cutaway portion, formed in each guide rail. By doing so, the present invention found that the upper and lower frames and the guide rails can be easily and certainly machined. The present invention further found that both engagement of each guide rail to an intermediate interlocking frame and disengagement of an intermediate interlocking frame from each guide rail can be performed quickly, simply and certainly.

According to the present invention, based on the above-mentioned knowledge, the intermediate interlocking frame can be engaged to or disengaged from a guide rail, with sash doors in an open state where no air-tightness or no airtight holding means can be obtained.

That is, according to the present invention, a sash system, wherein sash doors are opened and closed by sliding and folding, comprises a pair of sash doors including an inner sash door and an outer sash door, each of the sash doors including a vertical door front frame disposed on the right end of each sash door, a vertical door end frame disposed on the left end of each sash door, a horizontal divider panel connecting the door front frame and the end frame, and an intermediate interlocking frame disposed to a horizontal intermediate portion of the divider panel, the intermediate interlocking frame being two-folded horizontally with respect to a rotational shaft thereof; an upper sash frame and a lower sash frame; and an inner guide rail built in the upper frame and an outer guide rail built in the lower frame, the door front frame and the door end frame corresponding to each sash door being always engaged with the inner guide rail and with the outer guide rail, respectively. The intermediate interlocking frame is engaged so as to be detachable from each guide rail or from an interlocking frame guide rail in parallel to each guide rail. The sash system can arbitrarily select a first mode and a second mode, the first mode in which the sash doors are slidably opened and closed in an intermediate interlocking frame engaged state and the second mode in which each of the sash doors are folded in an intermediate interlocking frame disengaged state. The position where an intermediate interlocking frame in each sash door is engaged to and disengaged from each guide rail is set to the position where the sash doors are mutually slid from its closed state to its open state or is set to an opened position opposite to a closed position before movement.

According to the present invention, the airtight holder similar to that in the conventional double sliding sash system maintains high air-tightness. Meanwhile, each sash door can be arbitrarily opened and closed by sliding and folding.

In another embodiment of the invention, each guide rail has a cutaway communicating portion corresponding to the operation set position. An intermediate interlocking frame of each sash door is engaged to and detached from a corresponding guide rail through the cutaway communicating portion.

According to the present invention, in addition to the above-mentioned function and effect, the intermediate interlocking frame using the cutaway communicating portion can be engaged and disengaged certainly and easily.

In the sash system, the cutaway communicating portion is formed by cutting away a protrusion fin or protrusion wall of each guide rail in a U-shaped form, for engagement and disengagement of the intermediate interlocking frame.

In another embodiment of the invention, the cutaway communicating portion is formed by cutting away a protrusion fin or protrusion wall of each guide rail in an L-shaped form, for engagement and disengagement of the intermediate interlocking frame and for opening of the end of the divider panel.

According to the present invention, in addition to the above-mentioned function and effect, the cutaway communicating portion can be adjusted to the general relationship between the sash door and the sash frame to preferably perform engagement and detachment of the intermediate interlocking frame.

In the sash system, each sash door is arbitrarily moved to an opened position, opposite to a closed arrangement, in two steps including a home position where each sash door is opened and closed slidably and a “let it to go past” position where each sash door is displaced toward the vertical frame of the sash frame, whereby engagement and disengagement of the intermediate interlocking frame is set to the “let it to go past” position.

According to the present invention, in addition to the above-mentioned function and effect, opening/closing of each sash door by sliding and folding can be made at a different position. Meanwhile, because opening/closing through sliding becomes a normal mode, each sash door is not opened in a folded state while being opened by sliding it.

The sash system further comprises a door stopper for sash door movement position selection disposed between a vertical frame of a door end frame of a sash door and a vertical frame of the sash frame, for opening said sash door in the two steps.

According to the present invention, in addition to the above-mentioned function and effect, the simple, easy operation of the door stopper allows the two-step opening movement of each sash door to be selectively performed through sliding and through folding.

In the sash system, the door stopper can stand up or fall vertically or inwardly/outwardly to the door end frame of each sash door or to a vertical frame of a sash frame, whereby a displacement amount to a “let it to go past” position of a corresponding sash door or an effective operation length of each guide rail is varied in response to a standing or falling operation of the door stopper.

According to the present invention, in addition to the above-mentioned function and effect, because the door stopper can rise up and fall, the position where each sash door is opened and closed through sliding and folding can be selected more certainly.

In the sash system, each of the sash doors comprises a door stop framework, a door end frame, two divider panels disposed between the door stop framework and the door end frame, the divider panels having the same width, and a single intermediate interlocking frame disposed at an intermediate portion of each divider panel, whereby each of the sash doors can be quickly folded in a flat, V-shaped form for opening and closing.

In the sash system, each of the sash doors comprises a door stop framework, a door end frame, an even number of divider panels (being at least four divider panels) disposed between the door stop framework and the door end frame, the divider panels having the same width, and an even number of intermediate interlocking frames disposed at an intermediate portion of each divider panel, whereby each of the sash doors can be folded in a concertina form for opening and closing, the concertina form having fold lines corresponding to said even number.

According to the present invention, in addition to the above-mentioned function and effect, the entire basic structure of each sash door is specified while each sash door can be easily folded effectively through folding.

### BRIEF DESCRIPTION OF THE DRAWINGS

This and other objects, features, and advantages of the present invention will become more apparent upon a reading of the following detailed description and drawings, in which:

FIG. 1 is a front explanatory diagram fundamentally illustrating the main structure of a sash system according to an embodiment of the present invention, viewed from outside the room, wherein sash doors inside a sash frame are in a prefolding mode in which the sash doors are opened in a “let it go past” state;

FIG. 2 is a side cross-sectional view illustrating sash doors inside a sash frame, which are normally closed in a double sliding state, the upper portion of FIG. 2 corresponding to an indoor side and the lower portion of FIG. 2 corresponding to an outdoor side;

FIG. 3 is a side cross-sectional view illustrating sash doors, which are moved to a “let it go past” position inside a sash frame and corresponds to the state shown in FIG. 1, the upper portion of FIG. 3 corresponding to an indoor side and the lower portion of FIG. 3 corresponding to an outdoor side;

FIG. 4 is a side cross-sectional view illustrating sash doors inside a sash frame, which are opened outdoors through folding, the upper portion of FIG. 4 corresponding to an indoor side and the lower portion of FIG. 4 corresponding to an outdoor side;

FIG. 5 is a vertical cross-sectional view illustrating an enlarged entire structure, which has a divider panel portion in each sash door inside a sash frame, the upper portion of FIG. 5 corresponding to an indoor side and the lower portion of FIG. 5 corresponding to an outdoor side;

FIG. 6 is a vertical cross-sectional view illustrating an enlarged intermediate linkage portion to each sash door inside a sash frame, corresponding to the state in FIG. 1, the upper portion of FIG. 6 corresponding to an indoor side and the lower portion of FIG. 6 corresponding to an outdoor side;

FIG. 7 is a cross sectional view partially illustrating a door stopper before actuation, inside a sash frame, corresponding the state in FIG. 2, the upper portion of FIG. 7 corresponding to an indoor side and the lower portion of FIG. 7 corresponding to an outdoor side; and

FIG. 8 is an enlarged front view partially illustrating a door stopper after actuation, inside a sash frame, corresponding to the state in FIG. 1, viewed from an outdoor side.

### DETAILED DESCRIPTION OF A PREFERRED EMBODIMENT

A sash system that can open and close sash doors through sliding and folding, according to an embodiment of the present invention, will be described below by referring to the attached drawings.

In the embodiment, a sash system is built by assembling a rectangular sash frame integrally formed of upper, lower, right, and left frames, and two sash doors. The two sash doors include an inner sash door and an outer sash door, assembled inside the sash frame. The sash doors can horizontally slide in parallel differently to each other. Each sash door can be folded in two on the right or left side inside the sash frame. A simple changeover mechanism is attached to each sash frame to trigger a two-folded operation of each sash door. Along with the sash door opening/closing function through sliding, the changeover mechanism can arbitrarily perform a sash door opening/closing operation through folding, without disturbing the sash opening/closing operation through the normal sliding operation. Each sash door is opened through folding, if necessary.

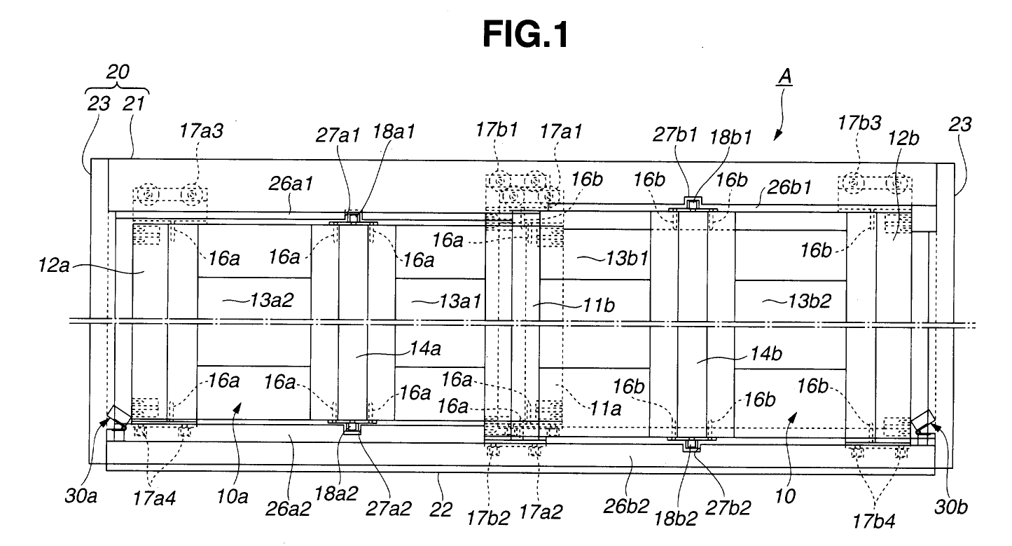

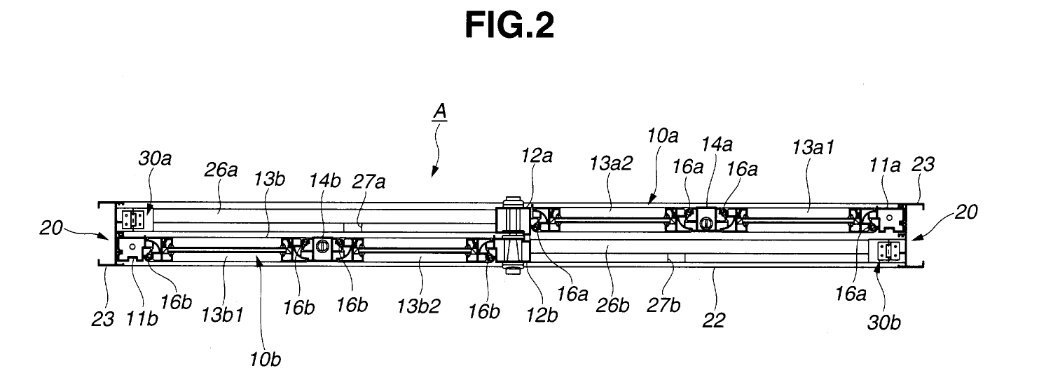

FIGS. 1 and 8 show the main constituent elements of a basic sash system according to an embodiment of the present invention. Both a sash opening/closing function through sliding and a sash opening/closing function through folding are explained here. Particularly, FIGS. 1 to 3 show the state before sash doors are opened through folding. In that state, an inner sash door and an outer sash door are moved to a “let it go past” position inside a sash frame and the intermediate interlocking frame of each sash door confronts a cutaway portion in a corresponding guide rail. FIG. 2 shows the “let it go past” mode of each sash door.

Referring to FIGS. 1 to 8, letter A represents a sash system according to the embodiment, in which sash doors can be freely opened and closed by sliding and folding. Referring to FIGS. 1 to 6, the sash system (A) basically comprises an integrated sash frame 20, and an inner sash door 10a and an outer sash door 10b, inserted in the sash frame 20. The sash frame 20 is built in a window or entryway of a room. Each sash door 10a, 10b is suspended to the sash frame 20 so as to travel (to open or close) under guide regulation.

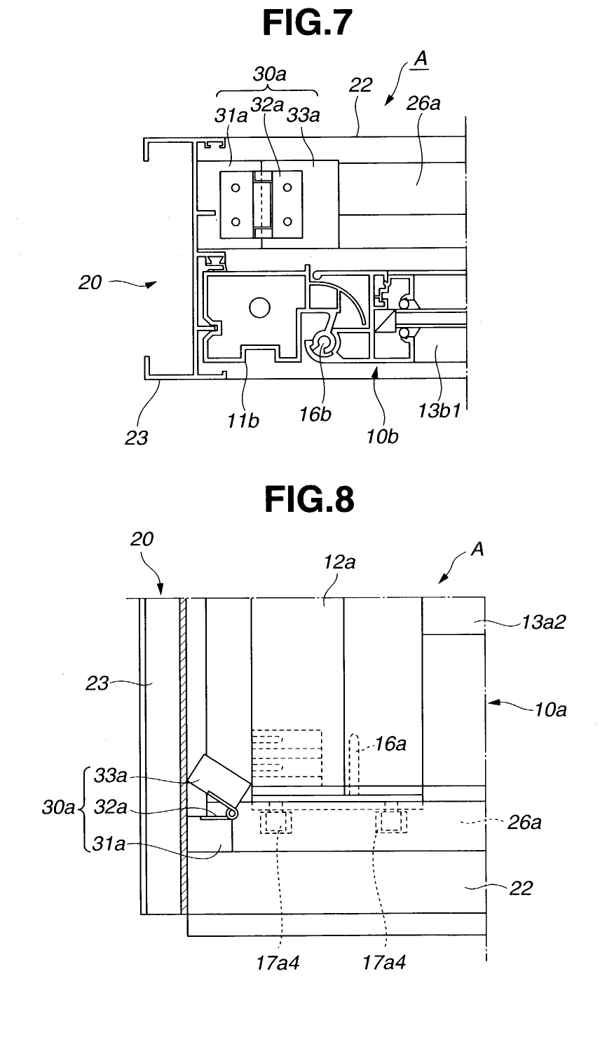

An operation member is disposed to each door as an engagement/disengagement mechanism that selectively opens and closes each sash door 10a, 10b by folding. As shown in detail in FIGS. 7 and 8, the door stopper 30a, acting as the main mechanism which switches opening and closing of the sash door 10a by sliding and folding, is disposed to the inner sash door 10a. The door stopper 30b, acting as the main mechanism which switches opening and closing of the sash door 10b by sliding and folding, is disposed to the inner sash door 10b.

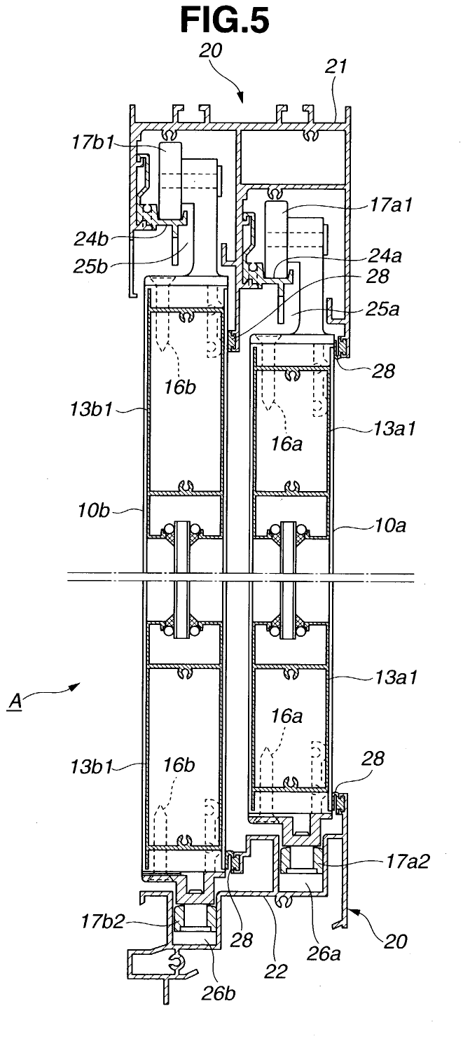

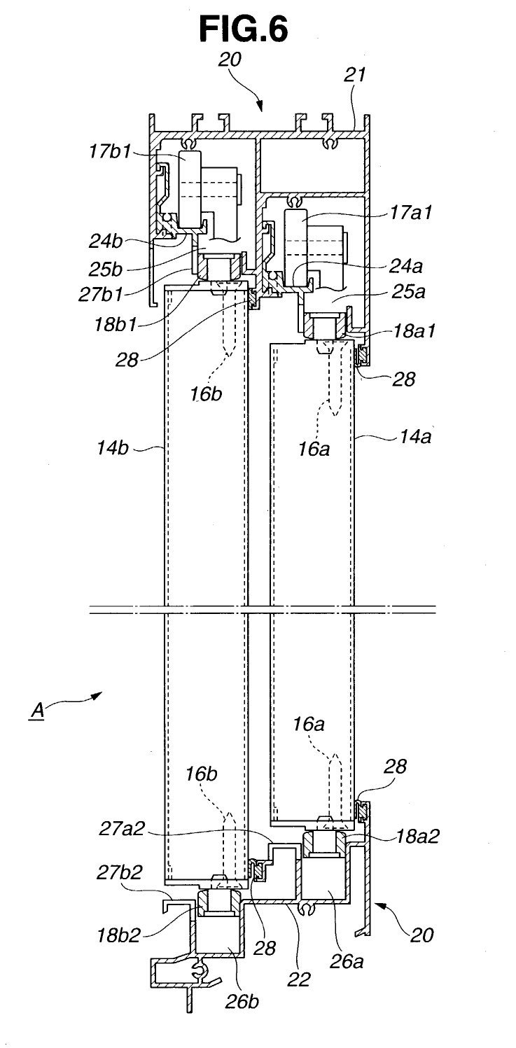

In uses of the sash door 10 a, 10b, various advantages can be obtained when the window or awning is opened outward by folding. Generally, as shown in FIGS. 5 and 6, the outer (outdoor) sash door 10b is slightly higher than the inner (indoor) sash door 10a.

The main members and the secondary constituent members associated with them (to be described later) are manufactured effectively and advantageously of, for example, aluminum section bars extruded in a desired cross-sectional shape, and/or composite members formed of aluminum section bars, resin section bars, and wooden section bars.

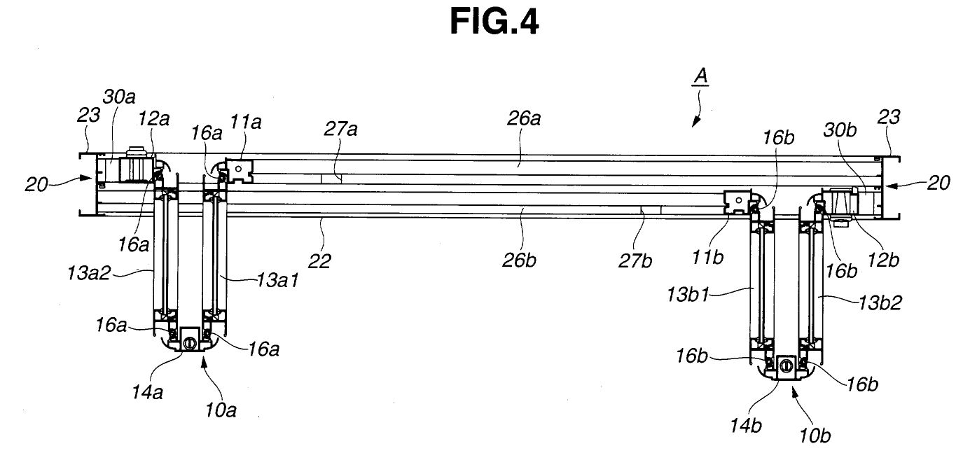

In the sash system (A), the sash frame 20 is securely fitted in a window or entryway of a room. The inner sash door 10a and the outer sash door 10b can travel inside the sash frame 20. If necessary, when the door stopper 30a is actuated, the sash door 10a is drawn against the left inner surface of the sash frame, with the sash door 10a folded (refer to FIG. 4). When the door stopper 30b is actuated, the sash door 10b is drawn against the right inner surface of the sash frame, with the sash door 10b folded (refer to FIG. 4).

In other words, the sash door 10a has a vertical door front frame 11a, a vertical door end frame 12a, and foldable divider panels 13a1 and 13a2. The foldable divider panels 13a1 and 13a2 are disposed between the door front frame 11a and the door end frame 12a and are connected together by means of an intermediate interlocking frame 14a disposed in the intermediate portion between the door front frame 11a and the door end frame 12a. The sash door 10b has a vertical door front frame 11b, a vertical door end frame 12b, and foldable divider panels 13b1 and 13b2. The foldable divider panels 13b1 and 13b2 are disposed between the door front frame 11b and the door end frame 12b and are connected together by means of an intermediate interlocking frame 14b disposed in the intermediate portion between the door front frame 11b and the door end frame 12b. (Refer to FIGS. 2 to 4)

As shown in FIGS. 5 and 6, an inner upper suspension roller 17a1 for suspension and rolling guide is loaded on the upper end of the door front frame 11a. An outer upper suspension roller 17b1 for suspension and rolling guide is loaded on the upper end of the door front frame 11b. An inner lower roller 17a2 for a rolling guide working as anti-vibration (or an inner or lower slush member for a slidable guide) is protruded at the lower end of the door framework 11a. An outer lower roller 17b2 for a rolling guide working as anti-vibration (or an inner slush member for a slidable guide) is protruded at the outer end of the door front frame 11b. Hinges 16a, 16a, which act as a rotational center for folding with respect to a fixed reference, are respectively fitted on the upper and lower ends of the door front frame 11a, 11b so as to get close to the outdoor side. (Refer to FIGS. 2 to 4)

This is also the case for the door end frames 12a and 12b. That is, an inner upper suspension roller 17a3 for suspension and rolling guide is loaded on the upper end of the door end frame 12a. An outer upper suspension roller 17b3 for suspension and rolling guide is loaded on the upper end of the door end frame 12b. An inner lower guide roller 17a4 for a rolling guide working as anti-vibration (or an inner slush member for a slidable guide) is protruded at the lower end of the door end frame 12a. An outer lower guide roller 17b4 for a rolling guide working as anti-vibration (or an outer slush member for a slidable guide) is protruded at the lower end of the door end frame 12b. Hinges 16b, 16b, which act as a rotational center for folding with respect to other fixed reference, are respectively attached on the upper and lower ends of the door end frame 12a, 12b so as to get close to the outdoor side. (Refer to FIGS. 2 to 4)

An inner upper guide roller 18a1 and an inner lower guide roller 18a2, each for rolling guide acting as an engagement/disengagement portion, respectively protrude from the upper and lower ends of the intermediate interlocking frame 14a. An outer upper guide roller 18b1 and an outer lower guide roller 18b2, each for rolling guide acting as an engagement/disengagement portion, respectively protrude from the upper and lower ends of the intermediate interlocking frame 14b. Hinges 16a and 16b acting as the rotational center with respect to a reference on the movable side are respectively fitted at the upper and lower portions on the interlocking frame 14a, 14b so as to get close to the indoor side. (Refer to FIG. 1 and FIGS. 5 and 6)

In the normal use mode of the inner sash door 10a and the outer sash door 10b, the sash doors 10a and 10b are slidably opened and closed under guide regulation by the sash frame 20 (to be described later), in a manner similar to the conventional manner. Specifically, in the closing mode as shown in FIG. 2, the door front frame 11a of the inner (indoor) sash door 1Oa is abutted against the right side vertical sash frame 20, with the sash doors 10a and 10b being flat (not folded). Thus, the door end frame 12a is separated from the left side vertical sash frame 20. The door end frame 11b of the outer sash frame 10b is abutted against the left side vertical sash frame 20, while the door end frame 12b is separated from the right side vertical sash frame 20. Thus, the door end frame 12a is aligned to the door end frame 12b. Furthermore, as shown in FIG. 4, the sash doors 10a and 10b can be open and closed through a folding operation. In this operation, the sash doors are folded outward from the room. However, if necessary, the sash doors may be folded inwardly to the room.

That is, in the inner (indoor) sash door 10a released from the guide regulation, each of both the door front frame 11a and the receiving end frame 12a acts as a reference on the fixed side. The intermediate interlocking frame 14a acts as a single reference on the movable side. Each hinge 16a acts as a rotational center. Thus, the divider panels 13a1 and 13a2 of the sash door 10a can be two-folded right and left in a substantially flat, V-shaped state. (Refer to the left portion of FIG. 4)

Similarly, in the outer (outdoor) sash door 10b, released from the guide regulation, each of both the door front frame 11b and the receiving frame 12b acts as a reference on the fixed side. The intermediate interlocking frame 14b acts as a single reference on the movable side. Each hinge 16b acts as a rotational center. Thus, the divider panels 13b1 and 13b2 of the sash door 10b are two-folded right and left in a substantially flat, V-shaped state. (Refer to the right portion of FIG. 4)

As well known, the sash frame 20 is integrally assembled of the upper horizontal frame 21, the lower horizontal frame 22, the right vertical frame 23, and the left vertical frame 23, to form a rectangular sash space.

An inner upper guide rail 24a, an outer upper guide rail 24b, an inner upper guide rail 25a, and an outer guide rail 25b are integrally built in the upper horizontal frame 21 (mainly refer to FIG. 1). The inner upper guide rail 24a supports an inner upper suspension roller 17a1 by suspension and rotatably guides it. The outer upper guide rail 24b supports an outer upper suspension roller 17b1 by suspension and rotatably guides it. The upper guide rail 25a is disposed in parallel to the inner upper guide rail 24a. The upper guide rail 25a guides the upper guide roller 18a1 so as to prevent vibration thereof. The upper guide rail 25b is disposed in parallel to the inner upper guide rail 24b. The upper guide rail 25b guides the upper guide roller 18b so as to prevents vibration thereof. (The inner upper guide rail 25a may be substituted for the upper guide rail 24a. The outer upper guide rail 25b may be substituted for the upper guide rail 24b.)

A communicating portion 27a1, 27b1 cut away in a U-shaped form is used as a passage for engagement and disengagement of the upper guide roller 18a1, 18b1 (refer to FIG. 1 and FIGS. 5 and 6). The communicating portion 27a1, 27b1 is formed at the position (to be described in detail later) where a protrusion fin extends downward on the outside of the upper guide rail 25a, 25b. In some cases, the cutaway communicating portion 27a1, 27b1 may be cut in an L-shape to open the end of the divider panel 13a1, 13a2.

Moreover, the inner lower guide rail 26a is integrally built in the lower horizontal frame 22 to prevent vibration of the inner lower guide roller 18a2. The outer lower guide rail 26b is integrally built in the lower horizontal frame 22 to prevent vibration of the outer lower guide roller 18b2. A U-shaped cutaway communicating portion 27a, acting as a passage for engagement and disengagement of the lower guide roller 18a2, is formed in a corresponding portion (to be described later) of the wall protruded from the outer surface of the inner lower guide rail 26a. A U-shaped cutaway communicating portion 27b, acting as a passage for engagement and disengagement of the lower guide roller 18b2, is formed in a corresponding portion (to be described later) of the wall protruded from the outer surface of the outer lower guide rail 26b. (Refer to FIG. 1 and FIGS. 5 and 6)

Referring to FIGS. 5 and 6, numeral 28 represents an elastic airtight member attached to a corresponding portion. The airtight member 28 can effectively seal hermetically the entire system.

Each of the inner door stopper 30a and the outer door stopper 30b can rise vertically (or outwardly or inwardly), turn, and fall. Only the inner (indoor) door stopper 30a is shown in FIGS. 7 and 8.

In the closing mode as shown in FIG. 2, the side of the left vertical frame 23 is opened by sliding the door front frame 11a of the sash door 10a against the right vertical frame 23 of the sash frame 20. In such a closing mode, the inner door stopper 30a is inserted between the left vertical frame 23 corresponding to the open side and the left, lower, inner surface of the lower guide rail 26a. The left end of the inner door stopper 23 butts against the vertical frame 23 (refer to FIGS. 7 and 8).

Moreover, the outer (outdoor) door stopper 30b is not shown in an enlarged state. However, as apparent from FIG. 1, the outer door stopper 30b is disposed symmetrically to the inner door stopper 30a. In the closing mode, the side of the write vertical frame 23 is opened by sliding the door front frame 11b of the sash door 10b against the left vertical frame 23 of the sash frame 20. In such a closing mode, the outer (outdoor) door stopper 30b is inserted between the right vertical frame 23 corresponding to the open side and the right, lower, inner surface of the lower guide rail 26b. The right end of the outer door stopper 30b butts against the right vertical frame 23.

FIGS. 7 and 8 show the door end stopper 30a for the inner sash door but do not show the door end stopper for the outer sash door because of the equivalent arrangement. The door end stopper 30a (30b in temporary number) is formed of a fixed base block 31a fixed directly on the lower, inner surface of the lower guide rail 26a (26b) and a movable block 32a (32b) supported rotatably to the fixed base block 31a (31b) by means of the hinge 32a (32b). In this example, the movable block 33a (33b) can stand up in the rail guide direction or fall down.

In the door end stopper 30a (30b) as shown in FIG. 8, the movable block 33a (33b) rotatably falls toward the fixed base block 31a (31b) so that the door stopper is expanded to a predetermined length. As a result, the effective operation length of the inner lower guide rail 26a is shortened. In other words, when the door stopper 30a (30b) expands, the effective operational lengths of the inner lower guide rail 26a in the sash door 10a and the outer lower guide rail 26b in the sash door 10b are substantially shorter than the length to the vertical frame 23. This is also the case for the inner upper guide rail 25a in the sash door 10a and the outer upper guide rail 25b in the sash door 10b.

By doing so, the effective operation, or the double sliding operation, between the closed position and the opened position of each sash door 10a, 10b is restricted to the shortened length. The open end of the door end frame 12a, 12b of the sash door 10a, 10b directly strikes the movable block 33a (32) expanded. Thus, further movement of the sash door 10a, 10b, that is, movement to the “let it go past” position is restricted. As a result, displacement to the “let it go past” position of each sash door 10a, 10b is disabled, through which each sash door 10a, 10b is changed from the expansion state (or opening/closing through sliding) to a laterally two-folded state (or opening/closing through folding).

For that reason, in the sash door 10a, the upper guide rail 25a guides the upper guide roller 18a1 and the lower rail 26a guides the lower guide roller 18a2. In the sash door 10b, the upper guide rail 25b guides the upper guide roller 18b1 and the lower rail 26b guides the lower guide roller 18b2. This operation allows the divider panels 13a1 and 13a2 to slide in a normally expanded state. As a result, the sash door 10a, 10b can be effectively opened and closed through the double sliding operation.

The movable block 33a (33b) rises up rotatably to the fixed base block 31a (31b) to change the operation mode, as shown in FIG. 8. Thus, the entire operation length is shortened to a predetermined value. This allows the effective operation length of the outer lower guide rail 26a to be extended. In other words, when the door stopper 30a, 30b is shortened, the effective operation lengths of the inner lower guide rail 26a and the inner upper guide rail 25a in the sash door 10a are substantially prolonged by the shortened length to the vertical frame 23. Similarly, the effective operation length of each of the inner lower guide rail 26b and the inner upper guide rail 25b in the sash door 10b is substantially prolonged by the shortened length to the vertical frame 23.

Thus, the effective operation range of the sash door 10a, 10b in the sliding operation is prolonged by the reduced length. The cutaway communicating portion 27a1 is set within only the reduced length range in the upper guide rail 25a. The cutaway communicating portion 27b1 is set within only the reduced length range in the upper guide rail 25b. The cutaway communicating portion 27a2 is set within only the reduced length range in the lower guide rail 26a. The cutaway communicating portion 27b2 is set within only the reduced length range in the lower guide rail 26b.

In such a case, the open end of the door end frame 12a, 12b of the sash door 10a, 10b can additionally move until it directly strikes the movable block 32a (32b) of a reduced length, thus performing the “let it go past” movement. Thus, the sash door 10a, 10b can be displaced to the “let it go past” position to change the mode to a laterally two-folded state (corresponding to opening/closing through folding) from an expanded state (corresponding to opening/closing through double sliding).

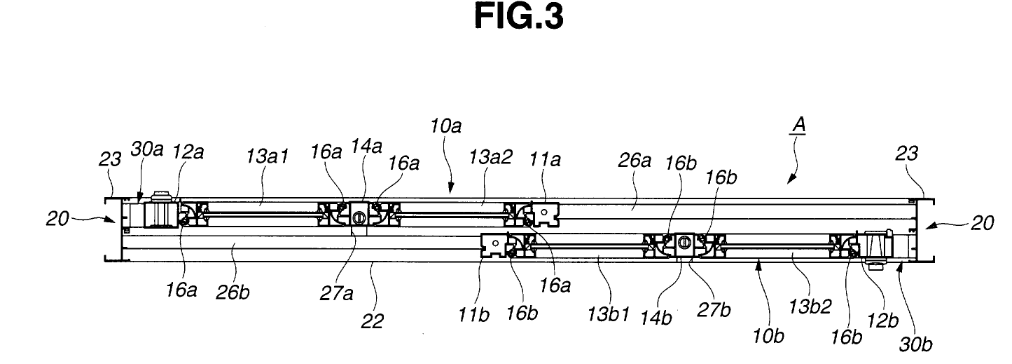

In the sash door 10a, the upper guide rail 25a guides the upper guide roller 18a1 while the lower guide rail 26a guides the lower guide roller 18a2. In the sash door 10b, the upper guide rail 25b guides the upper guide roller 18b1 while the lower guide rail 26b guides the lower guide roller 18b2. Thus, the sash doors 10a and 10b are slid to establish the arrangement opposite to the closed arrangement, as shown in FIGS. 1 and 3. During the “let it go past” operation, the upper guide roller 18a1 comes in contact with the upper cutaway communicating portion 27a1. Similarly, the upper guide roller 18b1 comes in contact with the upper cutaway communicating portion 27b1. The lower guide roller 18a2 comes in contact with the lower cutaway communicating portion 27a2. The lower guide roller 18b2 comes in contact with the upper cutaway communicating portion 27b2.

In the sash door 10a, the upper guide roller 18a1 engages with the upper guide rail 25a through the upper cutaway communicating portion 27a1. The lower guide roller 18a2 engages with the lower guide rail 26a through the lower cutaway communicating portion 27a2. In the sash door 10b, the upper guide roller 18b1 engages with the upper guide rail 25b through the upper cutaway communicating portion 27b1 (in a slide opening/closing state). The lower guide roller 18b2 engages with the lower guide rail 26b through the lower cutaway communicating portion 27b2. By starting with such an engagement state (an opening/closing state), the sash door 10a, 10b can be pushed out through separating or can be re-engaged inwardly through pushing. As a result, the window can be fully opened by folding the sash door 10a, 10b, as shown in FIG. 4.

That is, opening through sliding or opening through folding of the sash door 10a, 10b can be selected arbitrarily.

The door stopper 30a, being an engagement/disengagement mechanism to select the opening/closing operations, can be easily realized by means of a simple mechanism that can merely change the effective operation length of each of the guide rails 25a and 26a. The operation member 30b, being an engagement/detachment mechanism to select the opening/closing operations, can be easily realized by means of a simple mechanism that can merely change the effective operation length of each of the guide rails 25b and 26b

The present invention should be noted that further various modifications are possible, without being limited to only the above-mentioned embodiments. For example, each sash door may have divider panels of even numbers, which are foldable into concertina form. The door stopper may be an engagement/detachment mechanism detachable from each guide rail or from each sash frame. The door stopper may be firmly fixed on a corresponding door end frame. Various changes and modifications may be made without departing from the spirit or scope of the present invention.

What is claimed is:

1. A sash system for opening and closing sash doors by sliding and folding, comprising:
a pair of sash doors including an inner sash door and an outer sash door, each of said sash doors including a vertical door front frame disposed on the right end of each sash door, a vertical door end frame disposed on the left end of each sash door, a horizontal divider panel connecting said door front frame and said end frame, and an intermediate interlocking frame disposed to a horizontal intermediate portion of said divider panel, said intermediate interlocking frame being two-folded horizontally with respect to a rotational shaft thereof;
an upper sash frame and a lower sash frame; and
an inner guide rail built in said upper frame and an outer guide rail built in said lower frame, said door front frame and said door end frame corresponding to each sash door being always engaged with said inner guide rail and with said outer guide rail, respectively;
said intermediate interlocking frame being engaged so as to be detachable from each guide rail or from an interlocking frame guide rail in parallel to each guide rail;
wherein said sash system can arbitrarily select a first mode and a second mode, said first mode in which said sash doors are slidably opened and closed in an intermediate interlocking frame engaged state and said second mode in which each of said sash doors are folded in an intermediate interlocking frame disengaged state;
whereby the position where an intermediate interlocking frame in each sash door is engaged to and disengaged from each guide rail is set to the position where said sash doors are mutually slid from its closed state to its open state or is set to an opened position opposite to a closed position before movement.

2. The sash system as defined in claim 1, wherein each guide rail has a cutaway communicating portion corresponding to said operation set position, whereby an intermediate interlocking frame of each sash door is engaged to and detached from a corresponding guide rail through said cutaway communicating portion.

3. The sash system as defined in claim 2, wherein said cutaway communicating portion is formed by cutting away a protrusion fin or protrusion wall of each guide rail in a U-shaped form, for engagement and disengagement of said intermediate interlocking frame.

4. The sash system as defined in claim 2, wherein said cutaway communicating portion is formed by cutting away a protrusion fin or protrusion wall of each guide rail in an L-shaped form, for engagement and disengagement of said intermediate interlocking frame and for opening of the end of said divider panel.

5. The sash system as defined in claim 1, wherein each sash door is arbitrarily moved to an opened position, opposite to a closed arrangement, in two steps including a home position where each sash door is opened and closed slidably and a “let it to go past” position where each sash door is displaced toward the vertical frame of said sash frame, whereby engagement and disengagement of said intermediate interlocking frame is set to said “let it to go past” position.

6. The sash system as defined in claim 5, further comprising:
a door stopper for sash door movement position selection disposed between a vertical frame of a door end frame of a sash door and a vertical frame of said sash frame, for opening said sash door in said two steps.

7. The sash system as defined in claim 6, wherein said door stopper can stand up or fall vertically or inwardly/outwardly to said door end frame of each sash door or to a vertical frame of a sash frame, whereby a displacement amount to a “let it to go part” position of a corresponding sash door or an effective operation length of each guide rail is varied in response to a standing or falling operation of said door stopper.

8. The sash system as defined in claim 1, wherein each of said sash doors comprises a door stop framework, a door end frame, two divider panels disposed between said door stop framework and said door end frame, said divider panels having the same width, and a single intermediate interlocking frame disposed at an intermediate portion of each divider panel, whereby each of said sash doors can be quickly folded in a flat, V-shaped form for opening and closing.

9. The sash system as defined in claim 1, wherein each of said sash doors comprises a door stop framework, a door end frame, an even number of divider panels being at least four divider panels) disposed between said door stop framework and said door end frame, said divider panels having the same width, and an even number of intermediate interlocking frames disposed at an intermediate portion of each divider panel, whereby each of said sash doors can be folded in a concertina form for opening and closing, said concertina form having fold lines corresponding to said even number.
